(19) United States
(12) Patent Application Publication
(10) Pub. No.: US 2026/0147883 A1
(43) Pub. Date: May 28, 2026

(54) GRAND-SCALE UNIFIED AI-DRIVEN RAPID DISRUPTION

(71) Applicant: MICROSOFT TECHNOLOGY LICENSING, LLC, Redmond, WA (US)

(72) Inventors: Jovan KALAJDJIESKI, New Westminster (CA); Robert Lee MCCANN, Snoqualmie, WA (US); Bharat Jethalal VAGHELA, Morbi (IN)

(21) Appl. No.: 18/991,268

(22) Filed: Dec. 20, 2024

(30) Foreign Application Priority Data
Nov. 26, 2024 (IN) 202411092267

(51) Int. Cl. G06F 21/55

(52) U.S. Cl. CPC G06F 21/554

(57) ABSTRACT

Disclosed is an automated approach to disrupting cyberattacks. A temporal context-aware attention model—a type of sequence processing machine learning model referred to as “the model”—is trained to detect a cyberattack in real-time. Once detected, the cyberattack is automatically disrupted by disabling entities involved in the cyberattack. Information learned while disrupting the cyberattack is added to the training data to improve future iterations of the model. A novel temporal context-aware attention component of the model generates an attention matrix without a positional encoding. Instead, a positional encoding is combined with the attention matrix after it has been generated. The model employs close-in-time and long-term feature extractors to identify features from a sequence of event embeddings. Entities are encoded by their entity type, allowing the model to learn the contours of a cyberattack without overfitting on particular entity values.

### CROSS-REFERENCE TO RELATED APPLICATIONS

The present application is a non-provisional application of, and claims priority to, Indian Provisional Application Number 202411092267 filed on Nov. 26, 2024, the contents of which are hereby incorporated by reference in their entirety.

### BACKGROUND

In today's rapidly evolving cybersecurity landscape, organizations face a growing threat from increasingly sophisticated cyberattacks. Traditional defenses primarily rely on alerting systems that notify security teams of potential threats. However, these alerting systems merely signal the existence of a threat. Responding to the threat typically requires time-consuming and error prone manual intervention. Attempts have been made to implement disruption mechanisms that actively counter attacks upon detection, but these efforts remain limited in scope and volume. Current disruption strategies are tailored to specific attack scenarios. As such, they manage to counter only a small portion of incidents, leaving the vast majority unaddressed.

It is with respect to these and other considerations that the disclosure made herein is presented.

### SUMMARY

Disclosed is an automated approach to disrupting cyberattacks. A temporal context-aware attention model—a type of sequence processing machine learning model referred to herein as “the model”—is trained to detect a cyberattack in real-time. Once detected, the cyberattack is automatically disrupted by disabling entities involved in the cyberattack. Information learned while disrupting the cyberattack is added to the training data to improve future iterations of the model. A novel temporal context-aware attention component of the model generates an attention matrix without a positional encoding. Instead, a positional encoding is combined with the attention matrix after it has been generated. The model employs close-in-time and long-term feature extractors to identify features from a sequence of event embeddings. Entities are encoded by their entity type, allowing the model to learn the contours of a cyberattack without overfitting on particular entity values.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIGS. 1A-1H illustrate an end-to-end architecture for disrupting a cyberattack.

FIGS. 2A-2D illustrate performing a machine learning operation with a temporal context-aware attention model.

FIGS. 3A-3C illustrate locally encoding an entity associated with an event.

FIG. 4 is a flow diagram of an example method for performing a machine learning operation with a temporal context-aware attention model.

FIG. 5 is a flow diagram of an example method for locally encoding an entity associated with an event.

FIG. 6 is a flow diagram of an example method for disrupting a cyberattack.

FIG. 7 is a computer architecture diagram illustrating an illustrative computer hardware and software architecture for a computing system capable of implementing aspects of the techniques and technologies presented herein.

### DETAILED DESCRIPTION

In modern cybersecurity, most alert-based systems notify security teams of potential threats but fail to prevent the threats in real-time. Alerts may be sent seconds or hours after an attack begins, often long enough for the attack to progress significantly before being addressed. Once sent, manual intervention is still needed to interpret an alert in order to disable and remediate the attack. Furthermore, attackers often employ evolving, sophisticated methods that bypass existing defenses. Scenario-specific disruptors, particularly those that operate on low-level events and that are hand-crafted by security professionals, struggle to adapt to new attack patterns.

Disclosed is a comprehensive AI-driven cybersecurity system that autonomously detects and disrupts cyber threats in real-time. In various examples, “real-time” means that the cyberattacks are detected at a rate generally the same as a rate of a stream of event data from a system being monitored for cyberattacks. The system is designed to handle large-scale, multi-vector attacks by leveraging an innovative machine learning architecture. The system not only responds to threats as they happen but also adapts to various attack types and scenarios. The resulting protection far exceeds the limitations of traditional alert-based systems.

In some configurations, the system architecture observes input data such as events, alerts, evidence, and incidents as they are stored or as they occur on computing devices. Event schemas may be automatically identified, enabling new and different event types to be processed automatically. Entities associated with the observed input data, such as user accounts, IP addresses, file names, machines, email addresses, authentication applications, cloud resources, or other digital infrastructure components or identifiers are also identified.

In some configurations, additional entity attributes may be obtained for an entity and used to encode the input data associated with that entity. For example, the entity's reputation may be obtained from threat intelligence data, such as determining that an IP address has been associated with a nefarious actor. An entity's importance may be discerned from attributes about the entity, such as whether an account has administrative privileges, whether a machine's role is that of a server, or whether a file or file type is identified as containing sensitive information. Entity reputation, importance, and other similar factors may be encoded and provided as input when generating an embedding for the corresponding input data.

Entities may be locally encoded when generating an embedding of input data. In this context, the entity is encoded locally in that it is encoded in part by event type in relation to a particular triggering alert. The entity is not encoded by in its entirety the value of the entity, and the encoding of an entity in relation to the particular triggering alert does not affect how another entity of the same type and value relates to a different triggering alert. Encoding by event type in relation to a triggering alert enables the relationship between the entity and the triggering alert to be learned while avoiding overfitting an entity value.

The identified events, alerts, evidence, and incidents, and associated entities, are encoded as a sequence of embeddings. A temporal context-aware attention model uses historical alert data to learn from these embeddings. In some configurations, historical alert data includes historically remediated alerts—alerts that were analyzed and addressed manually—which may include a description of the resolution. Additionally, or alternatively, historical alert data includes disputed alerts data—alerts that were raised but later determined to be spurious. The temporal context-aware attention model may also be used to infer when a sequence of events, alerts, and incidents are predictive of a cyberattack.

An event is an action performed by a computing device. Events may be stored in tables, which are sources of events when training. For example, there may be eight different event tables, each table storing events of a particular type. These tables are logs containing descriptions of some or all actions performed by a user. For instance, identity log-on events hold information about every user's log-on activity, such as whether there were any unsuccessful log-ons, and why. Email events may be stored in their own table, such as emails sent, emails flagged, and emails deleted events, etc.

The model may also be trained on alerts, which are stored in an alerts table. Alerts are messages sent to interested parties notifying them about a potentially risky operation that took place. Alerts are themselves often generated based on an analysis of events. When multiple alerts are determined to be related, such as involving the same user, the same email address, or some other shared entity, they are correlated to form an incident. Incidents may be stored in an incidents table, and incidents may also be used to train the model.

An evidence table stores the entities that are associated with alerts, such as a user that the alert was referring to. An entity selection module may use the evidence table to determine which entities to disable when disrupting a cyberattack.

The ordered sequence of embeddings is provided to the temporal context-aware attention model. In some examples, the disclosed model leverages a convolution neural network (CNN) as part of a close-in-time feature extraction component, an LSTM based long-term feature extraction component, and a novel temporal context-aware attention mechanism. The close-in-time feature extraction component may perform convolutional feature extraction, or other methods, to automatically extract local features from the sequence of embeddings. For example, the CNN may operate as a sliding window over the sequence of embeddings, looking for features in turn. The long-term feature extraction component, in some examples, uses an LSTM to learn long term dependencies across larger portions of the sequence.

The sequence of embeddings is also provided to a temporal context-aware attention component, which is a kind of self-attention mechanism. The temporal context-aware attention component does not receive the output of the close-in-time feature extraction component or the long-term feature extraction component. Furthermore, the temporal context-aware attention component does not apply a positional encoding to its inputs. Instead, it computes a weighted sum of the features. The weights are determined when training by the importance of each part of the sequence in relation to every other part of the sequence. This allows the model to understand the context of each event in the sequence.

Another novelty is dynamic range positional encoding. In traditional positional encoding, as seen in transformer models and LLMs, each position in the input sequence is assigned a unique identifier before the attention matrix is computed. These unique identifiers are used by the model to understand the order of the sequence while the attention matrix is being computed. However, this technique fails to capture the relative importance of each position in the sequence.

The DRPE method addresses this issue by leveraging a sinusoidal function for the positional encoding and combining it with the already-computed attention matrix of importance scores. Specifically, an importance encoding in the form of an attention matrix is incorporated with the positional encoding, yielding a new sequence in which the value of each position reflects its original value and its relative importance.

Traditional attention heads apply a positional encoding before computing the attention matrix. However, a large amount of data is generally required to obtain meaningful results. In cases with less data, and in particular if there is a small amount of labeled data, transformers and traditional attention heads have trouble learning how events relate to one another.

The disclosed model can perform as well or better than traditional attention heads because short term dependencies are learned by the CNN separately from long term dependencies that are learned by the LSTM, which are learned separately from the attention mechanism. Allowing short term dependencies, long term dependencies, and attention to be learned separately enables the model to be trained effectively with less data than an attention-only framework.

An attention head of a transformer model requires at least 100,000 examples to have a good enough model. The disclosed embodiments were able to train the model effectively with only 10,000 examples, an order of magnitude improvement. This reduces the required amount of labeled data, which reduces cost. And the resulting model is significantly faster because it is smaller.

Identifying novel cyberattacks is a scenario in which data can be sparse, highlighting one of the advantages of the disclosed embodiments. While many attacks are attempted in high volume, generating ample training data, there are a number of edge cases, including novel attacks, that do not appear frequently enough to train traditional models.

The disclosed model architecture is not limited to cybersecurity, but could be applied to any type of sequence data. For example, the disclosed techniques could be used to train specialized language models, such as for lawyers or doctors. While the disclosed techniques perform better than traditional transformers with low amounts of training data, the results converge if there is a lot of data on which to train.

Once a cyberattack has been identified, an entity selection module identifies one or more entities to disrupt: users, emails, machines, or other entities to quarantine or otherwise remedy. Once the entities are identified the framework outputs an alert indicating that a cyberattack is happening followed by disabling one or more entities associated with the attack.

For example, the temporal context-aware attention model may determine that a user is the target of a phishing attack. Entities related to the attack are determined to include the phishing email and the user that was compromised. An alert might be generated to say “a phishing attack occurred resulting in a compromised user”, with the two evidences linked to the alert based on the alert ID. The framework may then disrupt the attack by disabling one or more of the entities, such as deleting the email, disabling the user, quarantining the machine, etc.

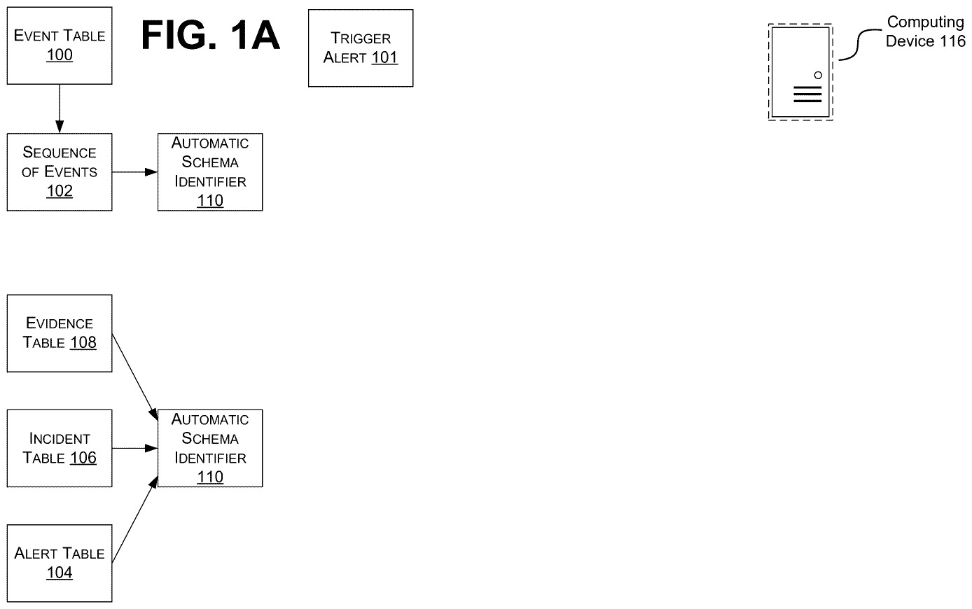

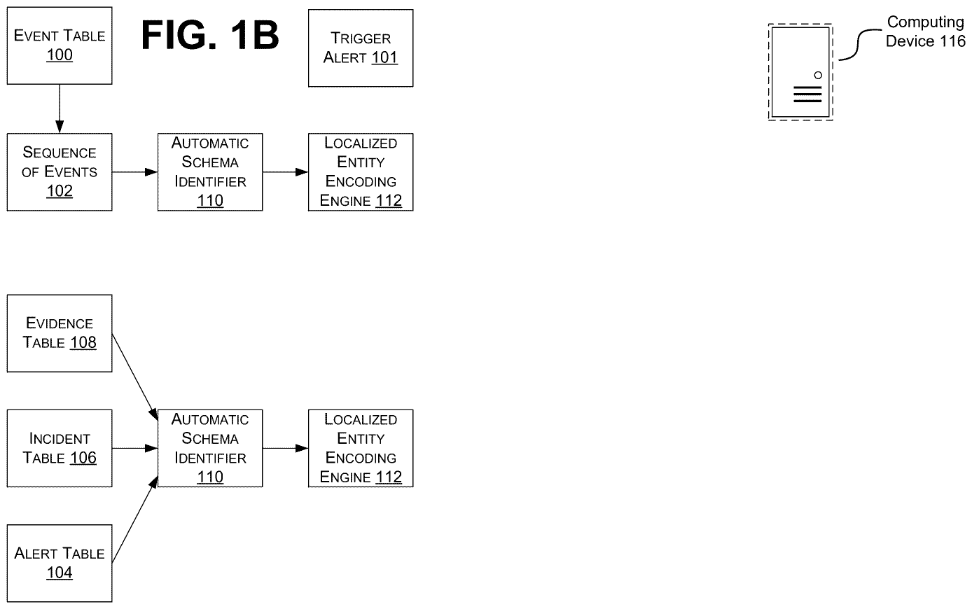

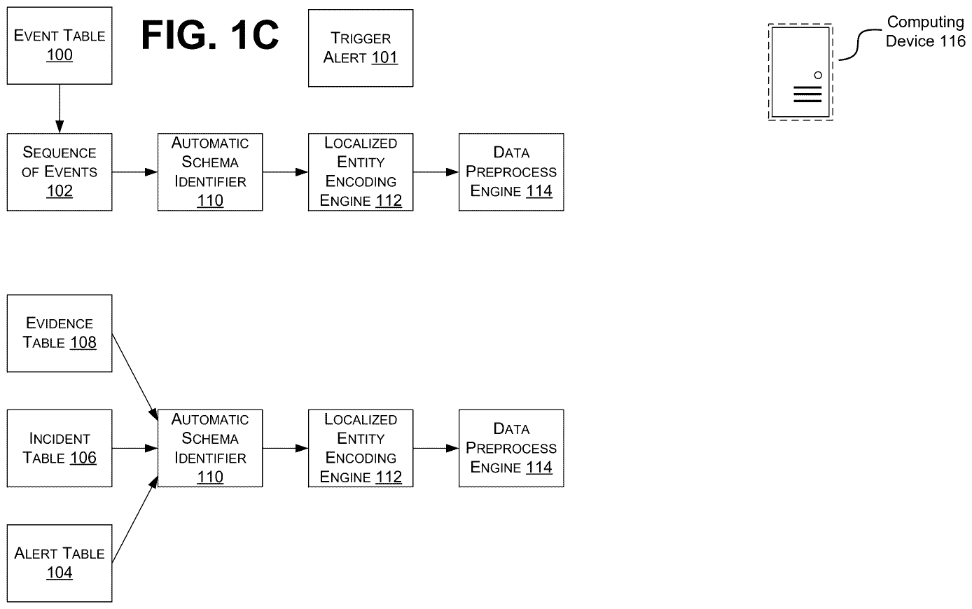

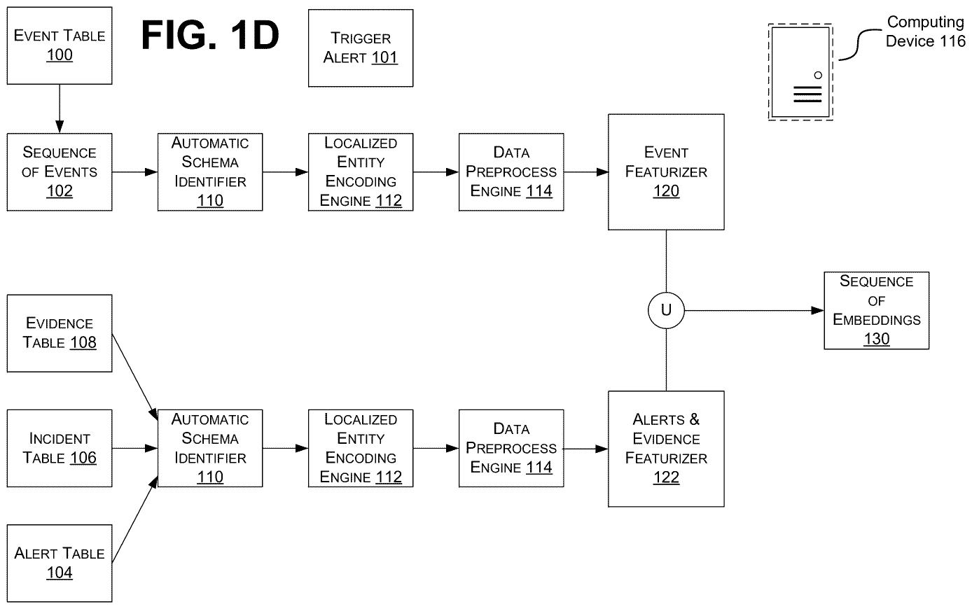

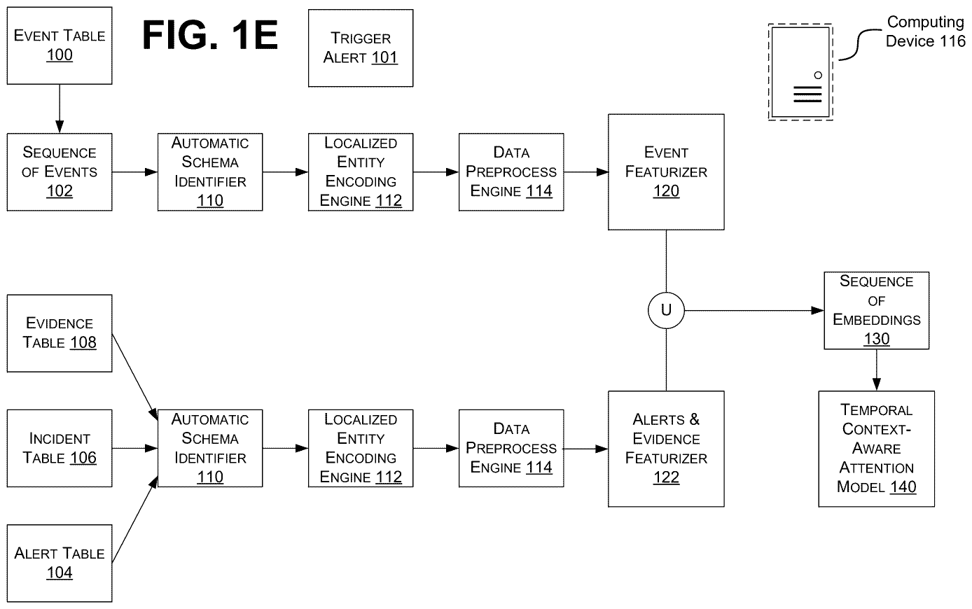

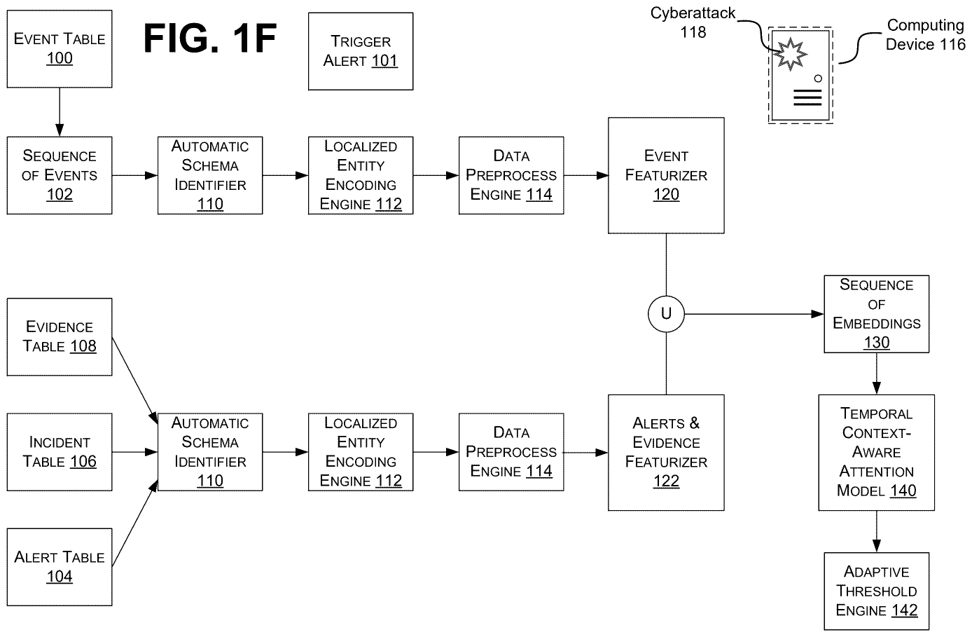

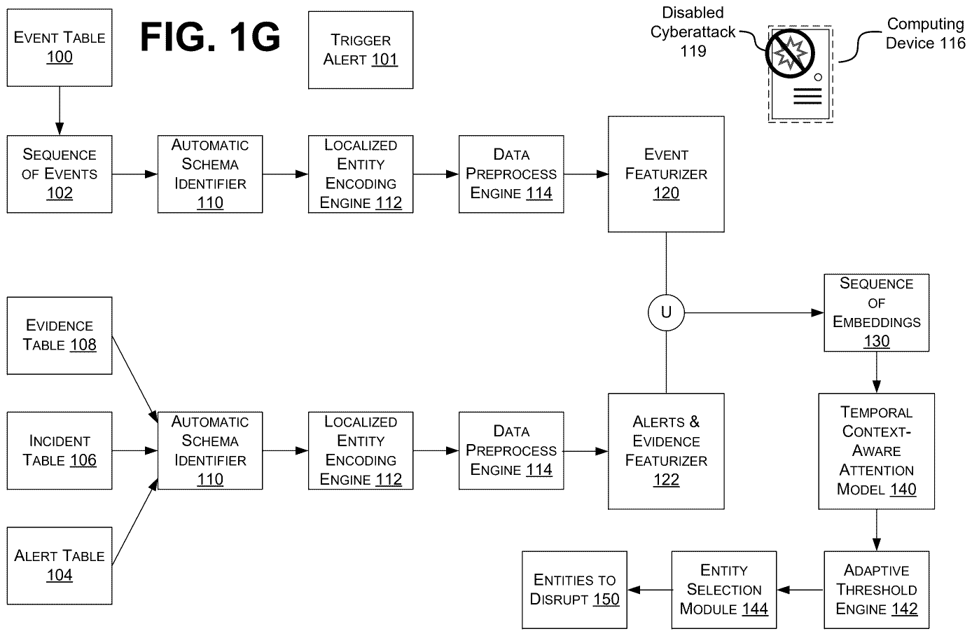

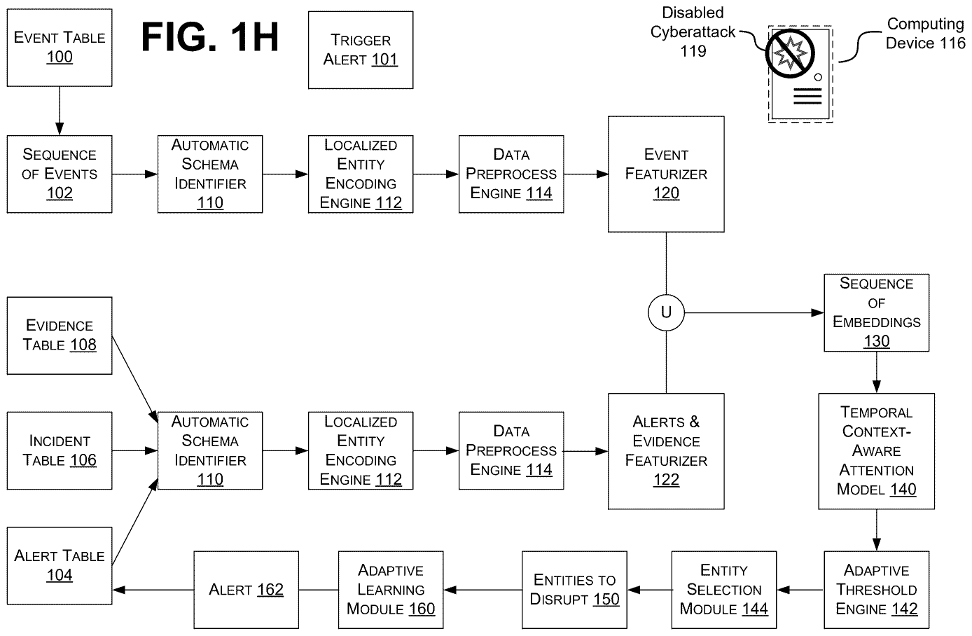

FIG. 1A illustrates obtaining events, alerts, incidents, and evidence that have occurred within monitored systems. This information is usable to train the model or to determine if a cyberattack is in progress. Sequence of events 102, which may include logins, file accesses, network usage, etc., are stored in tables such as event table 100. Event table 100 may be populated in real time by automated agents operating on monitored systems such as computing device 116. Similarly, alert table 104 stores alerts that themselves have been generated based on events such as sequence of events 102. As discussed herein, an alert describes suspicious activity that may be caused by a cyberattack.

In some configurations, the disclosed system identifies trigger alert 101—an alert that has been successfully disrupted over a recent time period, such as the previous 7 days. Alert 101 is a source of training data to learn to identify cyberattack 118. Alerts that are correlated to trigger alert 101 may be identified as additional information related to trigger alert 101 and/or cyberattack 118. Alerts may be considered correlated if they are found to have occurred within a defined period of time of trigger alert 101 or if they are implicitly linked by having a common attribute with trigger alert 101.

The disclosed architecture may then automatically gather events associated with entities of the alerts. It may also gather events that are associated with entities found in events that can be associated with the alerts. This ensures a comprehensive collection of data that provides a broader context for each alert. For instance, if an alert is triggered due to suspicious activity from a particular internet protocol (IP) address, all events associated with that IP address will be collected. This could include events such as failed login attempts, unusual data transfers, or changes in network traffic patterns. Then, if there was an event coming from that IP address that referred to a specific file, events related to that file will be collected, such as when and where the file was created, who accessed it, and what actions were taken on it.

A detailed timeline of activities related to each alert may be constructed with these events. This timeline—which is depicted as sequence of events 102, can provide valuable insights into a potential threat, such as how it started, how it is progressing, and what potential damage it could cause. This information may also be used to inform the disruption process, ensuring that it is targeted and effective.

Incident table 106 stores descriptions of incidents. An incident stitches together information from one or more alerts to describe a cyberattack. For example, if one alert identifies suspicious log-on behavior, and another alert identifies suspicious exfiltration of data, incident table 106 may be updated to include an incident describing a potential data exfiltration cyberattack. Evidence table 108 lists entities that have been identified as being used in or causing a cyberattack. Event table 100, alert table 104, incident table 106, and evidence table 108 are examples of input tables—sources of information that are converted to embeddings when learning to detect cyberattacks.

Automatic schema identifier 110 allows the framework to understand the schema without specifying it manually. This allows the framework to easily and automatically support additional data sources. Previous solutions required a manually constructed schema for each data source, such that adding additional data sources entailed significant overhead.

Specifically, automatic schema identifier 110 analyzes table entries of event table 100, alert table 104, incident table 106, and/or evidence table 108 to deduce data types of the data stored therein. For example, automatic schema identifier 110 may observe one or more rows of one of these tables, and from this sample, infer data types of each column. For example, numeric data may be distinguished from text-based data. Categorical column types, columns in which the values are one of a defined number of options, are identified and distinguished from columns that store continuous values. Dynamically inferring data types in this way allows the system to expand the number and types of inputs that may be automatically integrated into the system. In some examples the automatic schema identifier 110 comprises one or more rules. In some examples the automatic schema identifier comprises a generative machine learning model such as a large language model.

FIG. 1B illustrates encoding entities associated with events, alerts, and incidents. Localized entity encoding engine 112 receives entities associated with the events of sequence of events 102. As referred to herein, entities are actors or objects described by the events, alerts, and incidents. An entity has an entity value, such as the numeric values of an IP address. An entity is also often associated with a data type. For example, the data type of an IP address entity is “IP address” while the data type of a particular username is “username”. The term “localized” in this context refers to the fact that an encoding of an entity is specific to—local to-an alert, and not general across all alerts that refer to the same entity.

Localized entity encoding engine 112 may encode an entity or a portion of an entity by its entity type in lieu of its entity value. This avoids overdetermining the entity value, which is liable to change over time, and which may be used for a very different purpose in the context of a different alert. For example, a network address entity includes a network address such as an IP address. Network addresses are not stable identifiers—they are often released and re-allocated. Instead of encoding the entity with the network address itself, which is transient, one or more attributes of the entity as it relates to the associated event are encoded. For example, the network address—134.234.32.4—may be replaced with an index—1—indicating which network address this is in a sequence of network addresses that are associated with the event. Replacing actual values with attributes of the entity as it relates to the associated event/alert/incident allows the relationship between the entity and a prediction of a cyberattack to be learned.

While localized entity encoding may replace some entity values, such as an IP address or an email address, other aspects of the associated event are preserved. For example, the timestamp of the event that referenced the entity, the platform on which the event took place, etc., remain available for processing. Other examples of information usable to encode an entity include a count of instances of a particular entity type that are observed in a specified time interval, an average number of instances of the entity type in the time interval, a median number of the instances of the entity type in the time interval, or other statistic.

Localized encoding has been shown to reduce the size of the training data set needed to approximate the effectiveness of traditional transformer architectures. In one study a training data set produced using localized encoding yielded a temporal context aware attention model 140 that was approximately as effective as a large language model trained on an order of magnitude more data.

FIG. 1C illustrates preprocessing event, alert, incident, and entity data. Specifically, data preprocessing engine 114 uses data type information obtained by automatic schema identifier 110 to preprocess data into a format suitable for an embedding, such as a vector of numerical values. For example, One Hot Encoding may be applied to encode categorical column types, while word2vec may be used to transform textual data into word embeddings. Data preprocessing engine 114 may also fill in empty or missing values.

In some configurations, data preprocessing engine 114 implements feature extraction and selection in order to reduce the amount of training data and increase the clarity of training data. Specifically, data preprocessing engine 114 may implement and train a separate principal component analysis model on each of the different data sources. Principal component analysis models identify and select the most relevant data sources for the task. Less relevant data sources may be de-emphasized or removed completely.

FIG. 1D illustrates constructing and merging sequences of embeddings. Event featurizer 120 and alert & evidence featurizer 122 receive data emitted by data preprocessing engine 114. Featurizers 120 and 122 convert data associated with trigger alert 101 into embeddings. In an example, event featurizer 120 receives output from data preprocess engine 114, comprising, for each time interval of the sequence of events, a plurality of vectors. The event featurizer 120, for a given time interval, concatenates the vectors and outputs one vector for that time interval. The event featurizer repeats that process so as to output a stream of embedding vectors. These embeddings, from the event featurizer 120 and alerts and evidence featurizer 122 are merged into sequence of embeddings 130. In some cases this is done by concatenating the embedding vector for a given time interval from the event featurizer 120 with the embedding vector for the same time interval from the alerts and evidence featurizer 122. Event featurizer 120 may comprise rules or in some cases is a machine learning model. Alerts and evidence featurizer 122 may comprise rules or in some cases is a machine learning model.

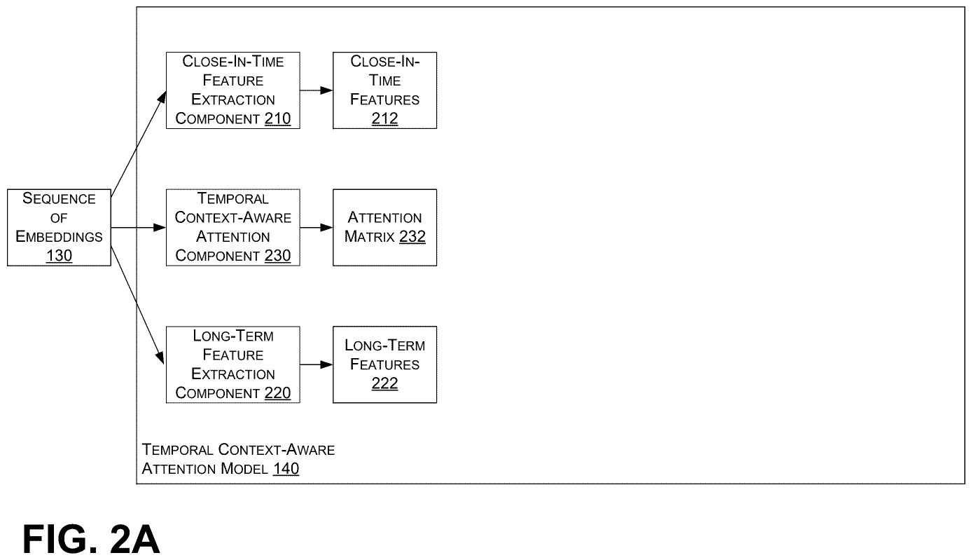

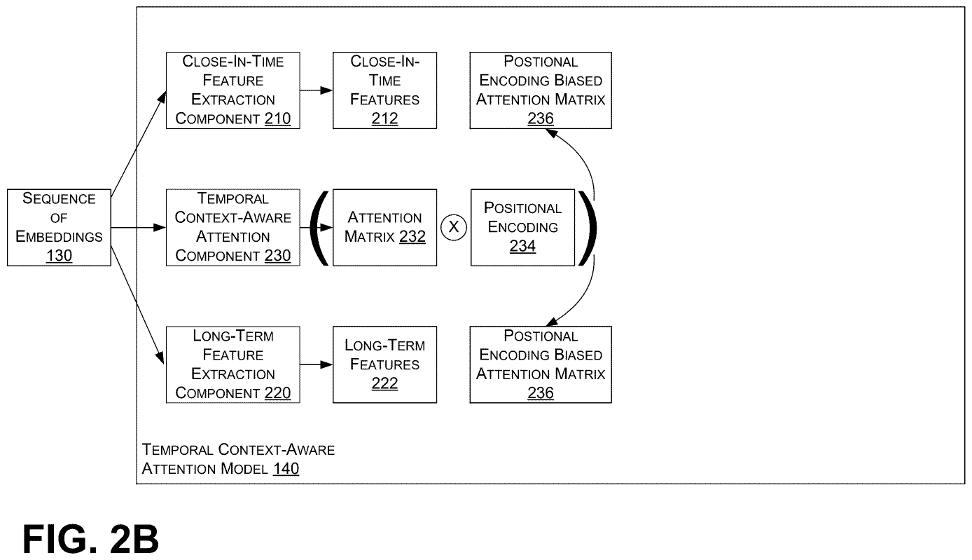

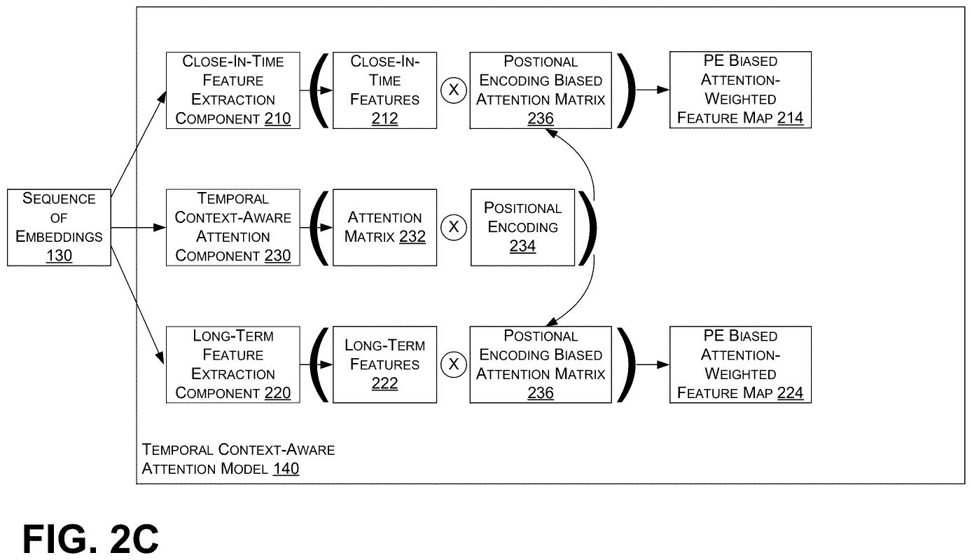

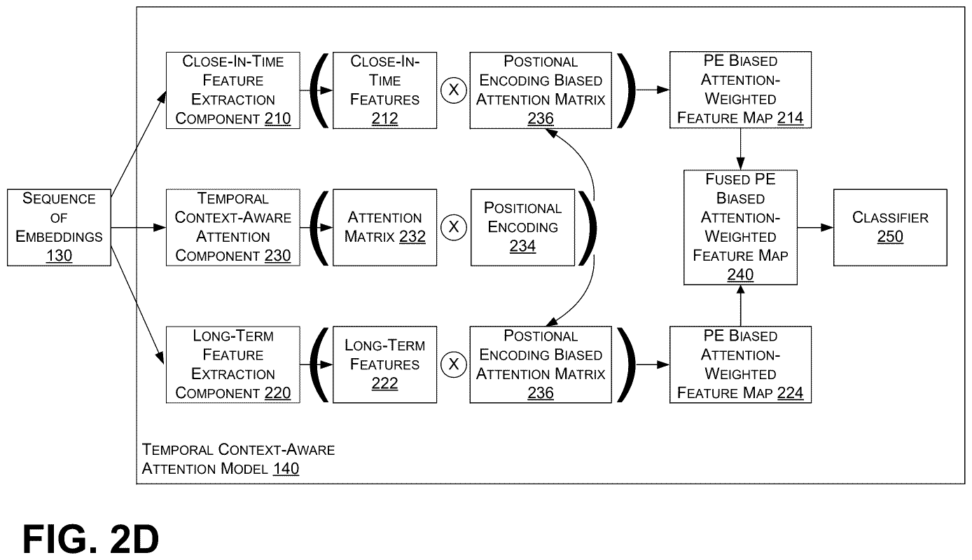

FIG. 1E illustrates using sequence of embeddings 130 to train or infer from temporal context-aware attention model 140. Temporal context-aware attention model 140 is a machine learning model described in more detail below in conjunction with FIGS. 2A-2D. Briefly, Temporal context-aware attention model 140 is a sequence model that identifies short-term features and long term features from sequence of embeddings 130. It applies a novel Temporal Context-Aware Attention component to generate an attention matrix without using positional encoding. This attention matrix is combined with a dynamic range positional encoding, and the resulting positional encoding biased attention-weighted feature map is used to apply attention and position to the features identified by the close-in-time and long-term feature extraction components. The result may be analyzed by a traditional transformer classifier.

In an example where the apparatus of FIG. 1E is used to train the temporal context aware attention model, the event data (i. e the data in event table 100, evidence table 108, incident table 106 and alert table 104) comprises information about the alert trigger 101 and so is known to be event data about either a cyberattack or benign event data. For a given event instance, the event data is processed through the pipelines illustrated in FIG. 1E to produce an entry in the sequence of embeddings. By repeating for more event instances a sequence of embeddings 130 is obtained where for each event instance there is information in the embedding about whether or not the event instance is a cyberattack. These embeddings are used to train temporal context-aware attention model 140.

In the case where the arrangement of FIG. 1E is used for inference, event data is provided to temporal context-aware attention model 140. Specifically, the event data, comprising entries in the event table, is processed as indicated in FIG. 1E and described above to produce a sequence of embeddings 130. The temporal context-aware attention model 140 processes the sequence of embeddings and outputs a Boolean classification. in some configurations the temporal context-aware attention model 140 may output certainty information associated with the prediction indicating how uncertain or certain the prediction is.

FIG. 1F illustrates learning the risk tolerance of different customers. Adaptive threshold engine 142 learns the risk tolerance of different customers, adjusting a threshold that determines how sure and/or severe a potential cyberattack has to be before it will be automatically disrupted. Risk tolerance can vary greatly between different tenants. The adaptive thresholding mechanism takes into account these differences in risk tolerance. It uses machine learning algorithms to learn from past disruptions and adjusts the threshold for future disruptions accordingly. For instance, if it learns that a tenant frequently labels disruptions as True Positive (TP) for small threats, it will lower the threshold for that tenant. Conversely, if it learns that a tenant only labels disruptions as TP for major threats, it will raise the threshold. In an example, where the certainty information associated with an output from the temporal context-aware attention model 140 is above the threshold, and the event is determined to be a cyberattack, an action is triggered to automatically mitigate or otherwise disrupt the cyberattack.

FIG. 1G illustrates disrupting cyberattack 118. In some configurations, entity selection module 144 applies a layered heuristic module to select which entities should be disrupted in order to disrupt the attack. When temporal context-aware attention model 140 gives a confidence value greater than a defined threshold—potentially a per-organization defined threshold—the system may disable, quarantine, or otherwise remediate cyberattack 118 as illustrated by disabled cyberattack 119. For example, the system may block an IP address entity, quarantine data that was uploaded during an attack, etc.

FIG. 1H illustrates adaptive learning. Adaptive learning module 160 allows the system to learn and adapt from its past predictions. This feedback loop allows the model to continuously improve performance over time. In some configurations, alert 162 is an alert generated by the system to convey the detection of cyberattack 118 by temporal context-aware attention model 140. Alert 162 may be generated and transmitted to the system administrator of computing device 116 to indicate that cyberattack 118 was identified. Additionally, or alternatively, alert 162 may be stored in alert table 104 for future rounds of training.

Event signal engine 146 applies event signal importance learning to the output of temporal context-aware attention model 140. Event signal importance learning identifies which event types are important in the context of detecting a cyberattack. In some configurations, event signal engine 146 uses a backpropagation through time approach to learn which event types are the most useful to detect a cyberattack. Event types which are determined to be most useful to detect a cyberattack are used by the automatic schema identifiers 110 in preference to other event types. Thus the event types used by the automatic schema identifiers 110 change over time according to the output of event signal engine 146. This effectively allows temporal context-aware attention model 140 to focus on the most important events, since other types of events may be filtered out by the automatic schema identifiers 110, improving the performance of temporal context-aware attention model 140 and increasing the effectiveness of data processing engines 114.

The system depicted in FIGS. 1A-1H describes a novel end-to-end disruption framework that stops attacks early and with high confidence. The framework utilizes a wide variety of signals, such as events, threat intelligence data, alerts, evidence, incidents, system administrator actions, and disruption actions etc. The framework uses this data to learn the patterns of what constitutes a real attack and how to stop attacks early in the attack chain. Previous solutions are either tailored towards specific scenarios (e.g. a tailored disruptor that targets ransomware attacks) which work at a very low volume, or are alert-based, thus not able to disrupt attacks early and frequently. As a comparison, while previous solutions only disrupt about 500-600 attacks daily, the disclosed framework is able to disrupt over one million attacks in a day with a precision of over 95%.

FIG. 2A illustrates temporal context-aware attention model 140 providing sequence of embeddings 130 to three different components: close-in-time feature extraction component 210, temporal context-aware attention component 230, and long-term feature extraction component 220. Each of these components may operate, at least initially, in parallel.

Close-in-time feature extraction component 210 may be implemented in part with a convolutional neural network (CNN) or other type of machine learning model. Close-in-time feature extraction component 210 may use a convolutional neural network to identify close-in-time features 212 over a short period of time. In contrast, long-term feature extraction component 220 may use a Long Short-Term Memory (LSTM) neural network, or other type of neural network, for learning long-term features 222. In some configurations the features of close-in-time features 212 and long-term features 222 indicate dependencies among embeddings. Dependencies between embeddings—which reflect on dependencies between the events of sequence of events 102 and any alerts, incidents, or evidence that has been encoded as one of sequence of embeddings 130—suggest coordination between events/alerts/incidents/evidence, which could be an indication of a cyberattack.

Temporal context-aware attention component 230 constructs attention matrix 232 from sequence of embeddings 130. Attention matrix 232 is an N×N matrix of importance values, where N is the number of embeddings in sequence of embeddings 130. Temporal context-aware attention component 230 does not first apply a positional encoding to sequence of embeddings 130. This is in contrast with existing techniques for computing an attention matrix, which often apply a sinusoidal positional encoding to the inputs of the attention mechanism.

FIG. 2B illustrates applying positional encoding 234 to attention matrix 232. In some configurations, positional encoding 234 comprises an N×N matrix of sinusoidal positions, which may be pre-computed or learned. Positional encoding 234 is multiplied by attention matrix 232 to obtain positional encoding biased attention matrix 236. Model 140 maintains positional information about sequence of embeddings 130 because close-in-time feature extraction component 210 and long-term feature extraction component 220 both independently maintain a concept of position.

Previous sequence models such as regular LSTM and transformer-based models require GPU-support and a big labeled dataset to train the models, and high inference cost. In comparison, model 140 is able to understand the context of each event in a sequence, enhancing its ability to detect patterns and anomalies, specifically allowing model 140 to do well in low-label scenarios (e.g., emerging attack types), function on lightweight platforms (e.g., no GPUs), reduce training and inference costs, and disrupt quickly and more accurately.

FIG. 2C illustrates applying positional encoding biased attention matrix 236 to the features identified by close-in-time feature extraction component 210 and long-term feature extraction component 220. Specifically, close-in-time features 212 are multiplied by positional encoding biased attention matrix 236 to obtain positional encoding (PE) biased attention-weighted feature map 214, and long-term features 222 are multiplied by positional encoding biased attention matrix 236 to obtain PE biased attention-weighted feature map 224.

FIG. 2D illustrates fusing PE biased attention-weighted feature map 214 and PE biased attention-weighted feature map 224 into fused PE biased attention-weighted feature map 240. The fusing may be done by adding the feature maps or aggregating them in other ways. Fused PE biased attention-weighted feature map 240 may then be provided to classifier 250, which is trained to determine whether sequence of embeddings 130 is indicative of cyberattack 118. Classifier 250 may be a transformer classifier, but other classifier architectures are similarly contemplated.

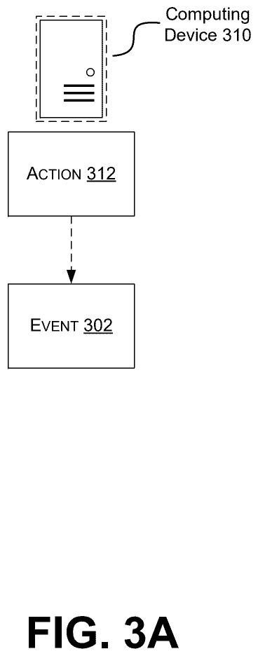

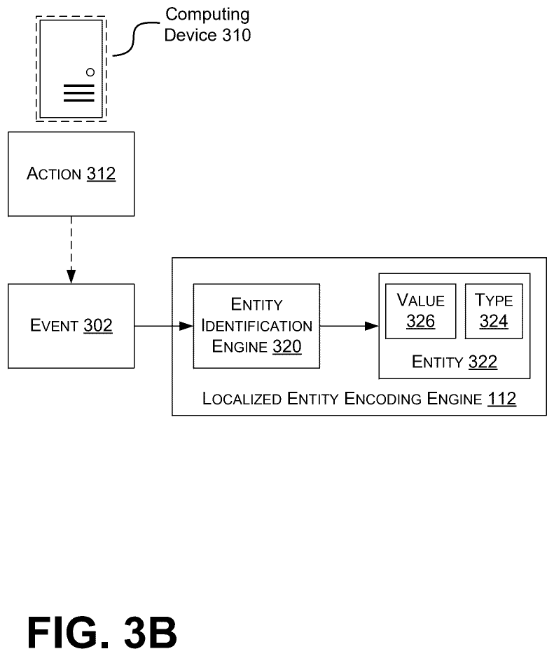

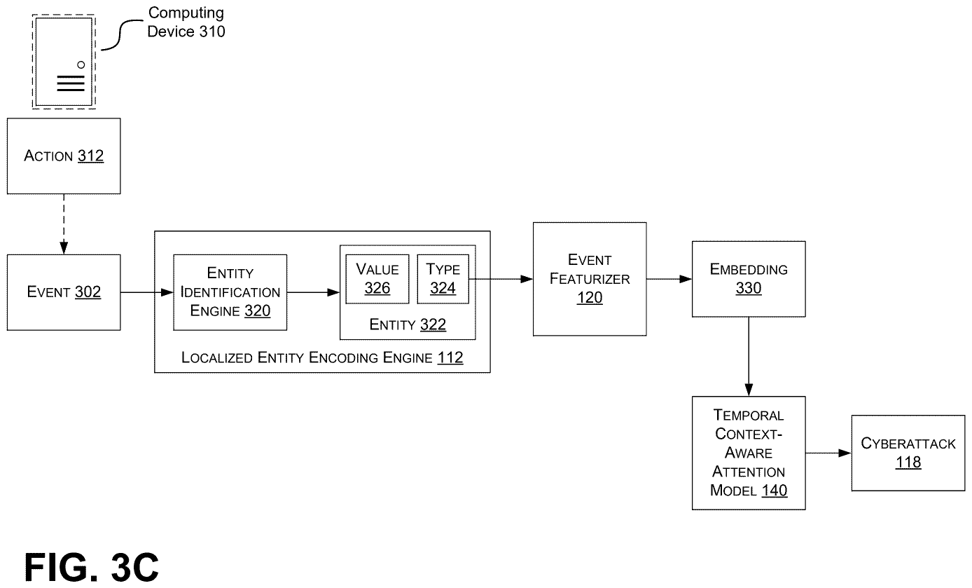

FIG. 3A illustrates obtaining event 302 that is associated with action 312 taken by computing device 310. Action 312 may be any operation performed by computing device 310, including user-initiated actions, operating system initiated actions, file system access, network access, user logins, among others.

FIG. 3B illustrates using entity identification engine 320 of localized entity encoding engine 112 to identify that entity 322 is associated with event 302. Entity 302 may be, for example, a target of action 312, such as a file that is a target of an encryption procedure. Entity 322 has value 326, such as the name of the file, and type 324, such as the name of the encryption procedure.

FIG. 3C illustrates a localized entity encoding engine 112. Event featurizer 120 performs localized entity encoding on type 324 of entity 322, yielding embedding 330. Value 326 may be partially or completely ignored when generating embedding 330. Embedding 330 is provided as input to temporal context-aware attention model 140 in order to identify cyberattack 118, as discussed above in conjunction with FIGS. 1A-1H.

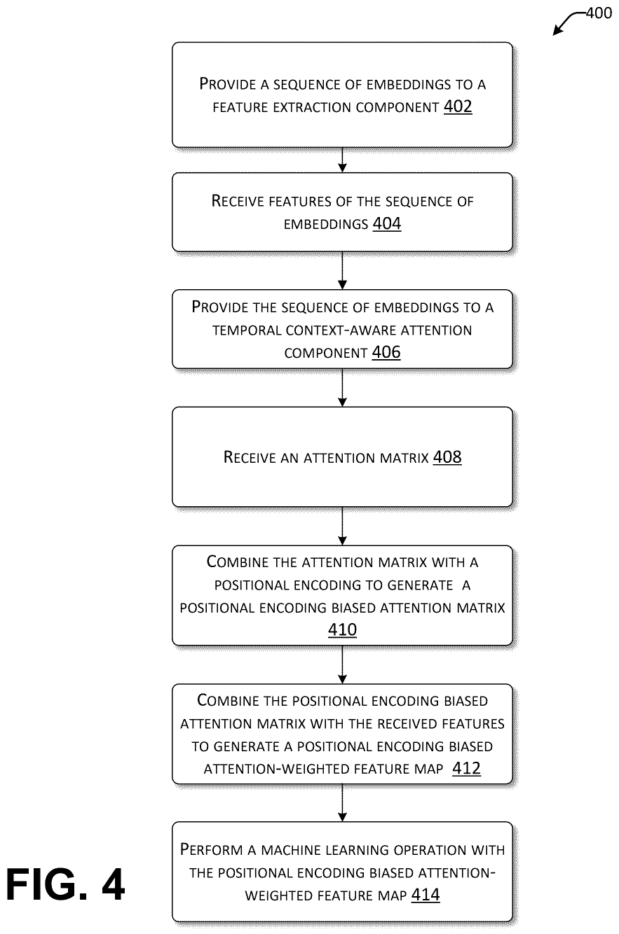

FIG. 4 is a flow diagram of an example method for performing a machine learning operation with a temporal context-aware attention model. Routine 400 begins at operation 402, where sequence of embeddings 130 are provided to feature extraction component 210 of machine learning model 140. Sequence of embeddings 130 may include embedding vectors generated from events, alerts, or incidents.

Next at operation 404, one or more features 212 of the sequence of embeddings 130 are received from one or more feature extraction components such as close-in-time feature extraction component 210 and/or long-term feature extraction component 220.

Next at operation 406, sequence of embeddings 130 is provided to temporal context-aware attention component 230 of machine learning model 140.

Next at operation 408, attention matrix 232 is received from temporal context-aware attention component 230.

Next at operation 410, attention matrix 232 is combined with positional encoding 234 to generate positional encoding biased attention matrix 236. For example, attention matrix 232 may be multiplied by positional encoding 234.

Next, at operation 412, positional encoding biased attention matrix 236 is combined with features 212 to generate positional encoding biased attention-weighted feature map 214.

Next, at operation 414, a machine learning operation is performed with positional encoding biased attention-weighted feature map 214. For example, positional encoding biased attention-weighted feature map 214 may be provided to classifier 250. The transformer classifier may be used to predict whether features 212 indicate a cyberattack.

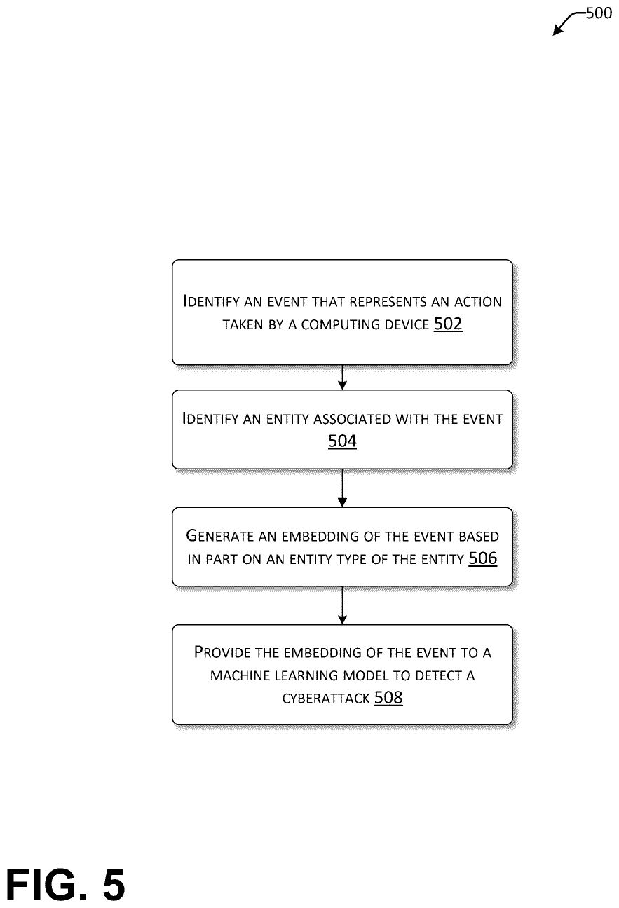

FIG. 5 is a flow diagram of an example method for locally encoding an entity associated with an event. Routine 500 begins at operation 502, where event 302 representing action 312 taken by computing device 310 is identified. For example, event 302 may be one of the events that triggered one of the alerts stored in alert store 104.

Next at operation 504, entity 322 associated with event 302 is identified, wherein entity 322 has an entity type 324 Entity type 324 describes the type of event, such as an IP address entity, a user entity, a computing device entity, or the like. Entity type 324 is in contrast to entity value 326, such as an actual IP address.

Next at operation 506, embedding 330 of event 302 is generated in part by encoding entity type 324. Other attributes of event 302 may also be used to generate embedding 330. Basing embedding 330 at least in part on entity type 324 instead of entity value 326 avoids overfitting, such as ascribing maliciousness to a transitory IP address that does not necessarily represent the same user or organization over time. Instead, encoding entity type 324 in the context of event 302 and associated alerts and incidents enables model 140 to discover the contours and relationships of a cyberattack. For example, model 140 is enabled to learn that the number of entities of a particular type or the amount of time between events associated with entities of particular types is indicative of cyberattack.

Next at operation 508, embedding 330 of event 302 is provided to machine learning model 140 to detect cyberattack 118. In some configurations, embedding 330 is used as part of an operation to train model 140, while in other configurations embedding 330 is used as part of an inference operation to classify whether a cyberattack has occurred.

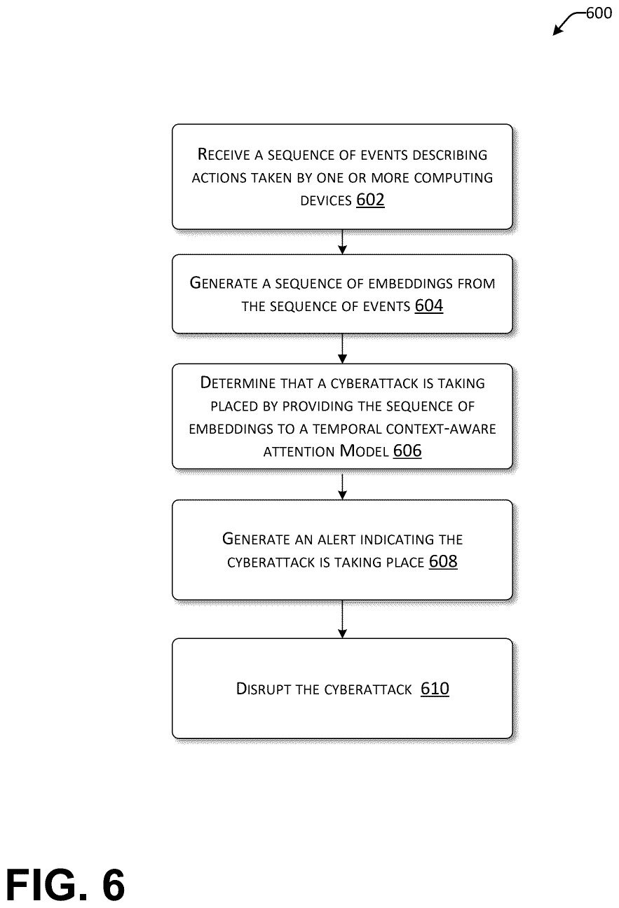

FIG. 6 is a flow diagram of an example method for disrupting a cyberattack. Routine 600 begins at operation 602, where sequence of events 102 describing actions taken by one or more computing devices 116 is received. In some configurations, sequence of events 102 is received from event table 100. Additionally, or alternatively, alerts from alert table 104, incidents from incident table 106, and evidence from evidence table 108 is also received and featurized by alerts & evidence featurizer 122.

Next at operation 604, sequence of embeddings 130 is generated for sequence of events 102 and from the featurized alerts, incidents, and evidence. Different types of data may be encoded in different ways. For example, text data may be encoded with word vectors, such as with word2vec, and One Hot Encoding may be applied to categorical column types.

Next at operation 606, a determination that cyberattack 118 is taking place is made by providing sequence of embeddings 130 to temporal context-aware attention model 140. In some configurations, temporal context-aware attention model 140 uses positional encoding biased attention matrix 236 computed by multiplying attention matrix 232 with positional encoding 234 to impart position biased attention to close-in-time features 212 and/or long-term features 222. The result is provided to classifier 250 to learn/infer whether sequence of embeddings 130 are indicative of cyberattack 118.

Next at operation 608, alert 160 indicating the existence of cyberattack 118 is generated.

Next at operation 610, cyberattack 118 is disrupted. For example, one of entities to disrupt 150 selected by entity selection module 144 may be disabled, quarantined, deleted, or otherwise remediated.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routines 400-600 are described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it should be appreciated that the operations of the routines 400-600 may be also implemented in many other ways. For example, the routines 400-600 may be implemented, at least in part, by a processor of another remote computer or a local circuit. In addition, one or more of the operations of the routines 400-600 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

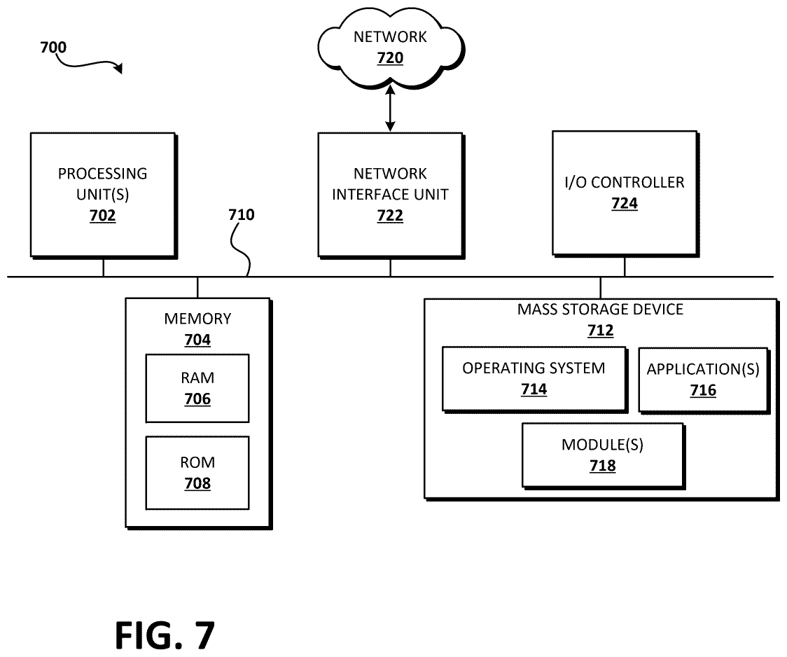

FIG. 7 shows additional details of an example computer architecture 700 for a device, such as a computer or a server configured as part of the systems described herein, capable of executing computer instructions (e.g., a module or a program component described herein). The computer architecture 700 illustrated in FIG. 7 includes processing unit(s) 702, a system memory 704, including a random-access memory 706 (“RAM”) and a read-only memory (“ROM”) 708, and a system bus 710 that couples the memory 704 to the processing unit(s) 702.

Processing unit(s), such as processing unit(s) 702, can represent, for example, a CPU-type processing unit, a GPU-type processing unit, a neural processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 700, such as during startup, is stored in the ROM 708. The computer architecture 700 further includes a mass storage device 712 for storing an operating system 714, application(s) 716, modules 718, and other data described herein.

The mass storage device 712 is connected to processing unit(s) 702 through a mass storage controller connected to the bus 710. The mass storage device 712 and its associated computer-readable media provide non-volatile storage for the computer architecture 700. Although the description of computer-readable media contained herein refers to a mass storage device, it should be appreciated by those skilled in the art that computer-readable media can be any available computer-readable storage media or communication media that can be accessed by the computer architecture 700.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 700 may operate in a networked environment using logical connections to remote computers through the network 720. The computer architecture 700 may connect to the network 720 through a network interface unit 722 connected to the bus 710. The computer architecture 700 also may include an input/output controller 724 for receiving and processing input from a number of other devices, including a keyboard, mouse, touch, or electronic stylus or pen. Similarly, the input/output controller 724 may provide output to a display screen, a printer, or other type of output device.

It should be appreciated that the software components described herein may, when loaded into the processing unit(s) 702 and executed, transform the processing unit(s) 702 and the overall computer architecture 700 from a general-purpose computing system into a special-purpose computing system customized to facilitate the functionality presented herein. The processing unit(s) 702 may be constructed from any number of transistors or other discrete circuit elements, which may individually or collectively assume any number of states. More specifically, the processing unit(s) 702 may operate as a finite-state machine, in response to executable instructions contained within the software modules disclosed herein. These computer-executable instructions may transform the processing unit(s) 702 by specifying how the processing unit(s) 702 transition between states, thereby transforming the transistors or other discrete hardware elements constituting the processing unit(s) 702.

The present disclosure is supplemented by the following example clauses:

Example 1: A method comprising: providing a sequence of embeddings to a feature extraction component of a machine learning model; receiving one or more features of the sequence of embeddings from the feature extraction component; providing the sequence of embeddings to a temporal context-aware attention component of the machine learning model; receiving an attention matrix from the temporal context-aware attention component; combining the attention matrix with a positional encoding of the sequence of embeddings to generate a positional encoding biased attention matrix; combining the positional encoding biased attention matrix with the one or more features to generate a positional encoding biased attention-weighted feature map; and performing a machine learning operation with the positional encoding biased attention-weighted feature map.

Example 2: The method of Example 1, wherein the sequence of embeddings encode a sequence of events, alerts, evidence, or incidents that describe actions taken by one or more computing devices, and wherein the machine learning operation detects a cyberattack.

Example 3: The method of Example 1, wherein the feature extraction component comprises a close-in-time feature extraction component that identifies close-in-time features by analyzing a subset of the sequence of embeddings that occurred within a defined time period.

Example 4: The method of Example 3, wherein the close-in-time feature extraction component includes a convolutional neural network.

Example 5: The method of Example 1, wherein the feature extraction component comprises a long-term feature extraction component that includes a memory for identifying long-term features.

Example 6: The method of Example 5, wherein the long-term feature extraction component includes a Long Short-Term Memory component.

Example 7: The method of Example 1, wherein the temporal context-aware attention component computes the attention matrix without a positional encoding.

Example 8: A non-transitory computer-readable storage medium having computer-executable instructions stored thereupon that, when executed by a processor, cause the processor to: observe an event that represents an action taken by a computing device; identify an entity associated with the event, wherein the entity has an entity type; generate an embedding of the event in part by encoding the entity type; and providing the embedding of the event to a machine learning model to detect a cyberattack.

Example 9: The non-transitory computer-readable storage medium of Example 8, wherein the embedding of the event is unrelated to a value of the entity.

Example 10: The non-transitory computer-readable storage medium of Example 8, wherein the entity comprises an internet address, a user, a machine, an email address, an authentication application, or a cloud resource.

Example 11: The non-transitory computer-readable storage medium of Example 8, wherein the event is encoded in part according to how many entities of the entity type are associated with an alert.

Example 12: The non-transitory computer-readable storage medium of Example 8, wherein the event is stored in an input table, wherein the instructions further cause the processor to: sample a row in the input table; identify a data type of a column of the input table using a value of the column in the sampled row; and generate the embedding of the event from the identified data type.

Example 13: The non-transitory computer-readable storage medium of example 8, wherein the event comprises a first event, wherein the embedding comprises a first embedding, and wherein the instructions further cause the processor to: identify a second event that is associated with the entity; generate a second embedding using in part an encoding of the second event; and provide the second embedding to the machine learning model.

Example 14: The non-transitory computer-readable storage medium of Example 8, wherein the event comprises a first event, wherein the entity comprises a first entity, wherein the embedding comprises a first embedding, and wherein the instructions further cause the processor to: identify a second event that is associated with an alert that describes the cyberattack; identify a second entity that is associated with the second event; identify a third event that is associated with the second entity; generate a second embedding from at least part of an encoding of the third event; and provide the second embedding to the machine learning model.

Example 15: A computing device comprising: a processor; and a non-transitory computer-readable storage medium storing computer-readable instructions that, when executed by the processor, cause the computing device to: receive a sequence of events that describe actions taken by one or more computing devices; generate a sequence of embeddings for the sequence of events; provide the generated sequence of embeddings to a temporal context-aware attention model to determine that a cyberattack is taking place, wherein the temporal context-aware attention model determines to disrupt the cyberattack using a positional encoding biased attention matrix computed by multiplying an attention matrix with a positional encoding; generate an alert indicating the cyberattack is taking place; and trigger disruption of the cyberattack.

Example 16: The computing device of Example 15, wherein the computer-readable instructions further cause the computing device to: select an entity associated with the alert; and disrupt the cyberattack by disabling the entity.

Example 17: The computing device of Example 15, wherein the instructions further cause the computing device to: store the generated alert in an alert store; and refine the temporal context-aware attention model using at least part of the generated alert.

Example 18: The computing device of Example 15, wherein a backpropagation through time approach over a classification model learns how likely event types are to predict disruption, wherein the instructions further cause the computing device to: filter events having an event type identified by the classification model as having above a defined likelihood of predicting disruption.

Example 19: The computing device of Example 15, wherein the temporal context-aware attention model is provided with embeddings of threat intelligence data, alerts of suspicious activity, or incident reports.

Example 20: The computing device of Example 15, wherein the temporal context-aware attention model computes an attention matrix of the generated embeddings, multiplies the attention matrix by a position encoding vector to obtain a positional encoding biased attention matrix, and multiplies a vector of features extracted by a neural network with the positional encoding biased attention matrix to apply position-aware attention to the features extracted by the neural network.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
providing a sequence of embeddings to a feature extraction component of a machine learning model;
receiving one or more features of the sequence of embeddings from the feature extraction component;
providing the sequence of embeddings to a temporal context-aware attention component of the machine learning model;
receiving an attention matrix from the temporal context-aware attention component;
combining the attention matrix with a positional encoding of the sequence of embeddings to generate a positional encoding biased attention matrix;
combining the positional encoding biased attention matrix with the one or more features to generate a positional encoding biased attention-weighted feature map; and
performing a machine learning operation with the positional encoding biased attention-weighted feature map.

2. The method of claim 1, wherein the sequence of embeddings encode a sequence of events, alerts, evidence, or incidents that describe actions taken by one or more computing devices, and wherein the machine learning operation detects a cyberattack.

3. The method of claim 1, wherein the feature extraction component comprises a close-in-time feature extraction component that identifies close-in-time features by analyzing a subset of the sequence of embeddings that occurred within a defined time period.

4. The method of claim 3, wherein the close-in-time feature extraction component includes a convolutional neural network.

5. The method of claim 1, wherein the feature extraction component comprises a long-term feature extraction component that includes a memory for identifying long-term features.

6. The method of claim 5, wherein the long-term feature extraction component includes a Long Short-Term Memory component.

7. The method of claim 1, wherein the temporal context-aware attention component computes the attention matrix without a positional encoding.

8. A non-transitory computer-readable storage medium having computer-executable instructions stored thereupon that, when executed by a processor, cause the processor to:
observe an event that represents an action taken by a computing device;
identify an entity associated with the event, wherein the entity has an entity type;
generate an embedding of the event in part by encoding the entity type; and
providing the embedding of the event to a machine learning model to detect a cyberattack.

9. The non-transitory computer-readable storage medium of claim 8, wherein the embedding of the event is unrelated to a value of the entity.

10. The non-transitory computer-readable storage medium of claim 8, wherein the entity comprises an internet address, a user, a machine, an email address, an authentication application, or a cloud resource.

11. The non-transitory computer-readable storage medium of claim 8, wherein the event is encoded in part according to how many entities of the entity type are associated with an alert.

12. The non-transitory computer-readable storage medium of claim 8, wherein the event is stored in an input table, wherein the instructions further cause the processor to:
sample a row in the input table;
identify a data type of a column of the input table using a value of the column in the sampled row; and
generate the embedding of the event from the identified data type.

13. The non-transitory computer-readable storage medium of claim 8, wherein the event comprises a first event, wherein the embedding comprises a first embedding, and wherein the instructions further cause the processor to:
identify a second event that is associated with the entity;
generate a second embedding using in part an encoding of the second event; and
provide the second embedding to the machine learning model.

14. The non-transitory computer-readable storage medium of claim 8, wherein the event comprises a first event, wherein the entity comprises a first entity, wherein the embedding comprises a first embedding, and wherein the instructions further cause the processor to:
identify a second event that is associated with an alert that describes the cyberattack;
identify a second entity that is associated with the second event;
identify a third event that is associated with the second entity;
generate a second embedding from at least part of an encoding of the third event; and
provide the second embedding to the machine learning model.

15. A computing device comprising:
a processor; and
a non-transitory computer-readable storage medium storing computer-readable instructions that, when executed by the processor, cause the computing device to:
receive a sequence of events that describe actions taken by one or more computing devices;
generate a sequence of embeddings for the sequence of events;
provide the generated sequence of embeddings to a temporal context-aware attention model to determine that a cyberattack is taking place, wherein the temporal context-aware attention model determines to disrupt the cyberattack using a positional encoding biased attention matrix computed by multiplying an attention matrix with a positional encoding;
generate an alert indicating the cyberattack is taking place; and
trigger disruption of the cyberattack.

16. The computing device of claim 15, wherein the computer-readable instructions further cause the computing device to:
select an entity associated with the alert; and
disrupt the cyberattack by disabling the entity.

17. The computing device of claim 15, wherein the instructions further cause the computing device to:
store the generated alert in an alert store; and
refine the temporal context-aware attention model using at least part of the generated alert.

18. The computing device of claim 15, wherein a backpropagation through time approach over a classification model learns how likely event types are to predict disruption, wherein the instructions further cause the computing device to:
filter events having an event type identified by the classification model as having above a defined likelihood of predicting disruption.

19. The computing device of claim 15, wherein the temporal context-aware attention model is provided with embeddings of threat intelligence data, alerts of suspicious activity, or incident reports.

20. The computing device of claim 15, wherein the temporal context-aware attention model computes an attention matrix of the generated embeddings, multiplies the attention matrix by a position encoding vector to obtain a positional encoding biased attention matrix, and multiplies a vector of features extracted by a neural network with the positional encoding biased attention matrix to apply position-aware attention to the features extracted by the neural network.
